(19) United States
(12) Patent Application Publication
(10) Pub. No.: US 2008/0156852 A1
(43) Pub. Date: Jul. 3, 2008

(54) SOLDER FLUX COMPOSITION AND PROCESS OF USING SAME

(76) Inventor: Anna M. Prakash, Chandler, AZ (US)

Correspondence Address: SCHWEGMAN, LUNDBERG & WOESSNER, P.A., P.O. BOX 2938, MINNEAPOLIS, MN, 55402, US

(21) Appl. No.: 11/617,811

(22) Filed: Dec. 29, 2006

(51) Int. Cl. B23K 35/362; B23K 31/02

(52) U.S. Cl. 228/256; 148/23

(57) ABSTRACT

A solder flux composition is formulated to lower contact wetting angles on bond pads, and to remain stable until the reflow temperature of the solder. A process includes contacting a bond pad with the solder flux composition and reflowing the solder bump that is in contact with the bond pad and the solder flux composition.

### TECHNICAL FIELD

Embodiments relate generally to integrated circuit devices. In particular, embodiments relate to solder flux compositions for integrated circuit devices.

### TECHNICAL BACKGROUND

Processors and other integrated circuit chips can generate significant heat. During miniaturization efforts, not only are circuits being crowded into smaller geometries, but also multiple chips are being crowded into smaller packages. Flip-chip configurations are affected by the miniaturization because mounting space is also shrinking. Consequently, bond pad and solder bump integrity is an increasingly important aspect of chip packaging.

### BRIEF DESCRIPTION OF THE DRAWINGS

In order to depict the manner in which the embodiments are obtained, a more particular description of embodiments briefly described above will be rendered by reference to exemplary embodiments that are illustrated in the appended drawings. Understanding that these drawings depict only typical embodiments that are not necessarily drawn to scale and are not therefore to be considered to be limiting of its scope, the embodiments will be described and explained with additional specificity and detail through the use of the accompanying drawings in which:

FIG. 1 is a computer-rendered image of a photomicrograph according to an embodiment;

FIG. 2 is a computer-rendered image of a photomicrograph according to an embodiment;

FIG. 3 is a computer-rendered image of a photomicrograph according to an embodiment;

FIG. 4A is a cross-section elevation of a integrated circuit package during solder flux processing according to an embodiment;

FIG. 4B is a cross-section elevation of the integrated circuit package depicted in FIG. 4A after further processing;

FIG. 4C is a cross-section elevation of the integrated circuit package depicted in FIG. 4B after further processing; and

FIG. 5 is a flow chart that describes process flow embodiments.

### DETAILED DESCRIPTION

The present disclosure relates to solder flux compositions that achieve lower contact wetting angles, and that remain stable up to the beginning of solder bump reflow.

The following description includes terms, such as upper, lower, first, second, etc. that are used for descriptive purposes only and are not to be construed as limiting. The embodiments of an apparatus or article described herein can be manufactured, used, or shipped in a number of positions and orientations. The terms “die” and “chip” generally refer to the physical object that is the basic workpiece that is transformed by various process operations into the desired integrated circuit device. A die is usually singulated from a wafer, and wafers may be made of semiconducting, non-semiconducting, or combinations of semiconducting and non-semiconducting materials. A board is typically a resin-impregnated fiberglass structure that acts as a mounting substrate for the die.

In various embodiments, the solder flux composition may be used as part of a soldering process for forming various integrated circuit devices. For the embodiments, a solder flux composition embodiment may remove oxide from a surface onto which soldering is to occur thereby increasing the ability of the solder to adhere to the surface of the substrate. In some embodiments, the solder flux composition embodiment may prevent oxide growth on a surface to be soldered as well as decreasing air and/or contaminants at the surface of the substrate.

For some embodiments, a solder flux composition may comprise an acid additive having a low weight percentage with respect to the total composition and in some of these embodiments, the low weight percentage may reduce the amount of degassing, bubbling, and/or hardening of a solder flux during thermal processing such as bump reflow.

Organohalide-Containing Solder Flux Compositions

In an embodiment, a solder flux composition includes an organohalide. A first group of solder flux compositions include a carboxylic acid, a surfactant, a resin, an amine, a solvent, the organohalide; and the solution, reaction, and mixture products thereof.

Where a carboxylic acid is used, a weight % range from about 0.1% to about 20% can be used. In an embodiment, the acid a mono-carbolylic acid such as glycolic acid. The carboxylic acid can be a dicarboxylic acid according to an embodiment. In an embodiment, the dicarboxylic acid is malonic acid. In an embodiment, the dicarboxylic acid is succinic acid. In an embodiment, the dicarboxylic acid is glutaric acid. In an embodiment, the dicarboxylic acid is adipic acid. In an embodiment, the dicarboxylic acid is pimelic acid. In an embodiment, the dicarboxylic acid is tartaric acid. In an embodiment, a dicarboxylic acid is mixed with a mono-carboxylic acid.

Where a solvent is used, a weight % range from about 1% to about 50% is used. In an embodiment, the solvent is a diol such as propanediol. In an embodiment, the solvent is an ether such as dipropylene glycol monomethyl ether (DPGME). In an embodiment, the solvent is an ether acetate such as ethylene glycol monoethyl ether acetate. In an embodiment, a combination of at least two of the solvents can be used.

In some embodiments, a surfactant is used to reduce the surface tension at the interface of flux residue and water thereby allowing the water to remove the flux residue effectively from a surface of a substrate. A surfactant additive in accordance with various embodiments may be one or more commercially-available surfactants. For example, in some embodiments, Envirogem AD01 surfactant sold by Air Products and Chemicals, Inc. may be used as a surfactant additive. Other surfactants may be enlisted in accordance with various embodiments.

Where a surfactant is used, sometimes referred to as a flow modifier, the specific surfactant employed depends upon compatibility with the solder flux composition. In an embodiment, the surfactant is anionic such as long chain alkyl carboxylic acids, such as lauric acids, steric acids, and the like. In an embodiment, the surfactant is nonionic. Examples of nonionic surfactants are polyethylene oxides, poly propylene oxides, and the like. In an embodiment, the surfactant is cationic such as alkyl ammonium salts such as tert butyl ammonium chlorides, or hydroxides. In an embodiment the flow modifier is provided in a range from about 0.1% to about 10% by weight of the total solder flux composition when it is prepared.

In some embodiments, an amine is used. In an embodiment, the amine is an alkyl substituted amine. In an embodiment, the amine is an ethanol amine. In an embodiment, the amine is an ethoxylated amine. In an embodiment, the amine is a propoxylated amine.

In an embodiment, a liquid primary aromatic diamine is used. One example liquid primary aromatic diamine is diethyldiaminotoluene (DETDA), which is marketed as ETHACURE® 100 from Ethyl Corporation of Richmond, Va. Another example liquid primary aromatic diamine is a dithiomethyldiaminotoluene such as Ethacure® 300. Another example liquid primary aromatic diamine is an alkylated methylenedianiline such as Lapox® K-450 manufactured by Royce International of Jericho, N.Y.

In an embodiment, a liquid hindered primary aliphatic amine is used. One example liquid hindered primary aliphatic amine is an isophorone diamine. Another example liquid hindered primary aliphatic amine is an alkylated methylenedianiline such as Ancamine® 2049 manufactured by Pacific Anchor Chemical Corporation of Allentown, Pa.

In an embodiment, a liquid secondary aromatic amine is used. One example liquid secondary aromatic amine embodiment is an N,N′-dialkylphenylene diamine such as Unilink® 4100 manufactured by DorfKetal of Stafford, Tex. Another example liquid secondary aromatic amine embodiment is an N,N′-dialkylmethylenedianilines: i.e. Unilink® 4200.

In various embodiments, a solder flux composition may comprise less than about 40 weight % of the amine. In another embodiment, a solder flux composition of a mixture of acids, amines, and a mixture of solvents is used.

In an embodiment, a resin is used to provide tackiness of the solder flux composition to the bond pad and the solder bump up to an including the time of reflow. The solder flux composition may include the resin, which may be present in an amount of from about 0% to about 90% by weight based on the organic components present.

In an embodiment, a cycloaliphatic epoxy resin is used. In an embodiment, a bisphenol A type epoxy resin is used. In an embodiment, a bisphenol-F type epoxy resin is used. In an embodiment, a novolac epoxy resin is used. In an embodiment, a biphenyl type epoxy resin is used. In an embodiment, a naphthalene type epoxy resin is used. In an embodiment, a dicyclopentadiene-phenol type epoxy resin is used. In an embodiment, a combination of any two of the resins is used. In an embodiment, a combination of any three of the resins is used. In an embodiment, a combination of all four of the resins is used.

Examples of the organohalide-containing and carboxylic acid solder flux composition were tested at 230° C. for both contact angle and wetting of the solder bump. The solder bump that was used was a lead solder and the solder bump was reflowed onto a copper bond pad. The solder-flux composition includes about 6.3% carboxylic acid, about 2% surfactant, about 20% amine, about 30% resin for tackiness, about 2% organohalide, and the balance a solvent of diol. Table 1 reflects the results.

TABLE 1

| | | | Solder |
|---|---|---|---|
| | | | wetting |
| | | Contact | at 230° C. |
| | | angle, | reflow, |
| Example | Solder Flux Composition | degrees | mm |
| 1 | Composition + 2% ethylhexylamine | 14.7 | 1.67 |
| | hydrobromide | | |
| 2 | Composition + ethylhexylamine | 12.8 | 1.75 |
| | hydrobromide + 10% surfactants | | |
| 3 | Composition + 2% ethylhexylamine | 12 | 1.79 |
| | hydrobromide + higher BP solvent | | |
| 4 | Composition + 2% 2,3-dibromo- | 13.5 | 1.71 |
| | 1,4-butanediol | | |
| 5 | Composition + 2% 2,3-dibromo- | 11.8 | 1.81 |
| | 1,4-butanediol + 10% surfactants | | |

Tartaric Acid and Organohalide-Containing Solder Flux Compositions

In an embodiment, a solder flux composition includes tartaric acid and an organohalide. A second group of solder flux compositions include the tartaric acid, a resin, an amine, a solvent, the organohalide; and the solution, reaction, and mixture products thereof. The tartaric acid-containing solder flux composition can be obtained from Senju America, Inc. of Great Neck, N.Y. One selected solder flux composition from Senju is Senju 42™.

Examples of the tartaric acid and organohalide solder flux composition were tested at 230° C. for both contact angle and wetting of the solder bump. The solder bump that was used was a lead solder and the solder bump was reflowed onto a copper bond pad. The solder-flux composition included Senju 42™ and about 2% organohalide. The organic acid and the resin together form metal acetate complexed polymer rings around solder bumps, which can prevent ion migration in reliability testing. Table 2 reflects the results.

TABLE 2

| | | | Solder |
|---|---|---|---|
| | | | wetting |
| | | Contact | at 230° C. |
| | | angle, | reflow, |
| Example | Solder Flux Composition | degrees | mm |
| 6 | Composition + 2% ethylhexylamine | 16.5 | 1.6 |
| | hydrobromide | | |
| 7 | Senju 42 + 2% 2,3-dibromo- | 14.1 | 1.69 |
| | 1,4-butanediol | | |

Mono-tert-butyl Succinate-Containing Solder Flux Compositions

In an embodiment, a solder flux composition includes a mono-tert-butyl succinate and the solder flux composition used in Examples 1-5. Examples of the mono-tert-butyl succinate solder flux composition were tested at 230° C. for both contact angle and wetting of the solder bump. The solder bump that was used was a lead solder and the solder bump was reflowed onto a copper bond pad. Table 3 reflects the results.

TABLE 3

| | | | Solder |
|---|---|---|---|
| | | | wetting |
| | | Contact | at 230° C. |
| | | angle, | reflow, |
| Example | Solder Flux Composition | degrees | mm |
| 8 | Composition + 0.5% | 25 | 1.38 |
| | mono-tert-butyl succinate | | |
| 9 | Composition + 2% | 22 | 1.46 |
| | mono-tert-butyl succinate | | |

Tartaric Acid and Increased Surfactant-Containing Solder Flux Compositions

In an embodiment, a solder flux composition includes tartaric acid and an increased amount of surfactant, compared to other examples. The solder-flux composition included Senju 42™ and about 10% surfactant. Table 4 reflects the results.

TABLE 4

| | | | Solder |
|---|---|---|---|
| | | | wetting |
| | | Contact | at 230° C. |
| | | angle, | reflow, |
| Example | Solder Flux Composition | degrees | mm |
| 10 | Senju 42 + 10% surfactant | 18–22 | 1.4–1.5 |

Reference will now be made to the drawings wherein like structures will be provided with like reference designations. In order to show the structures of embodiments most clearly, the drawings included herein are diagrammatic representations of various embodiments. Thus, the actual appearance of the fabricated structures, for example in a photomicrograph, may appear different while still incorporating the essential structures of embodiments. Moreover, the drawings show only the structures necessary to understand the embodiments. Additional structures known in the art have not been included to maintain the clarity of the drawings.

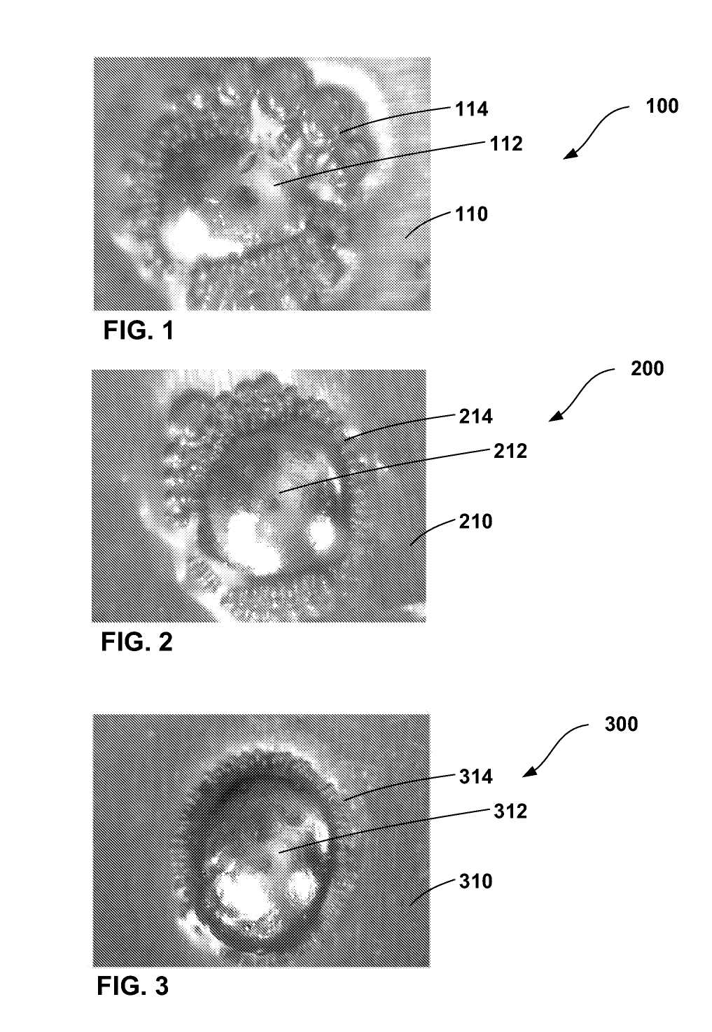

FIG. 1 is a computer-rendered image of a photomicrograph 100 according to an embodiment. A bond pad 110 displays a solder bump 112 that has been reflowed after a solder flux composition embodiment was applied between the solder bump 112 and the bond pad 110. A mixture of Senju 42™ and 10% surfactant was used, and reflow of the solder bump 112 was carried out at 230° C. A bubble region 114 is illustrated that resulted in some volitalization of the solder flux.

FIG. 2 is a computer-rendered image of a photomicrograph 200 according to an embodiment. A bond pad 210 displays a solder bump 212 that has been reflowed after a solder flux composition embodiment was applied between the solder bump 212 and the bond pad 210. A mixture of a composition set forth in Table 1, such as Examples 1 and 4, including the carboxylic acid and the 2% organohalide, was used. Reflow of the solder bump 212 was carried out at 230° C. The bubble region 214 is illustrated that resulted in some volitalization of the solder flux, but the bubble region 214 is smaller than that of the bubble region 114 depicted in FIG. 1. Consequently, although the bubble region 114 is a result of an embodiment, the bubble region 214 results in a more likely solder reflow that avoids solder wicking open (SWO). The term SWO means that volitalization of the solder flux is significant enough to disturb the solder bump on the bond pad site to a degree that insufficient solder will be present to complete a viable reflow of the solder bump.

FIG. 3 is a computer-rendered image of a photomicrograph 300 according to an embodiment. A bond pad 310 displays a solder bump 312 that has been reflowed after a solder flux composition embodiment was applied between the solder bump 312 and the bond pad 310. A mixture of a composition set forth in Table 1, such as Examples 2 and 5, including the carboxylic acid and the 2% organohalide, was used. Reflow of the solder bump 312 was carried out at 230° C. The bubble region 314 is illustrated that resulted in some volitalization of the solder flux, but the bubble region 314 is smaller than that of the bubble regions 114 and 214 depicted in FIGS. 1 and 2, respectively. Consequently, the bubble region 314 results in a more likely solder reflow that avoids SWO.

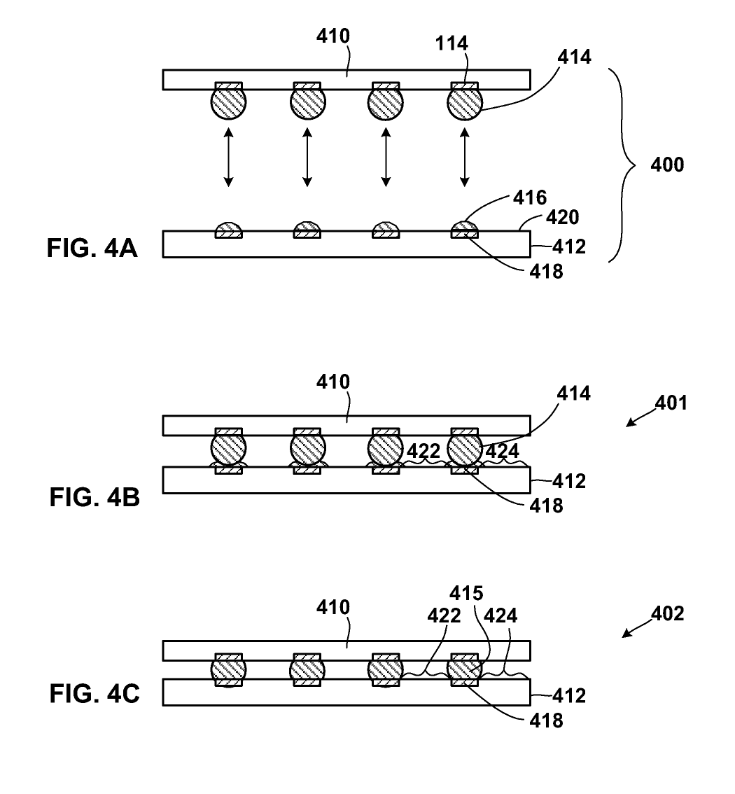

FIG. 4A is a cross-section elevation of an integrated circuit package 400 during solder flux processing according to an embodiment. An integrated circuit (IC) die 410 is flip-chip disposed above a mounting substrate 412 and is to be electrically coupled to the mounting substrate 412 through a series of electrical bumps, one of which is indicated with the reference numeral 414.

A solder flux composition 416 is depicted as having been deposited upon the mounting substrate 412. The solder flux composition 416 has wetted a bond pad 418 that is disposed upon the upper surface 420 of the mounting substrate 412.

Depositing of the solder flux composition 416 is done by X-Y grid spraying according to an embodiment. Alternatively, depositing of the solder flux composition 416 is done by stencil applying according to an embodiment. Alternatively, depositing of the solder flux composition 416 is done by substrate dipping into a solder-flux reservoir according to an embodiment.

FIG. 4B is a cross-section elevation of the integrated circuit package depicted in FIG. 1A after further processing. The IC package 401 depicts reflow of the solder bump 414, such that it is reflowing without the solder drawing too far from the bond pad 418 from a first keep-out zone (KOZ) 422 toward a second KOZ 424. The KOZs are regions that must remain clear of solder flux materials for further packaging needs, and that also would create possible SWOs if the solder is allowed to blunder into these zones.

FIG. 4C is a cross-section elevation of the integrated circuit package depicted in FIG. 4B after further processing. The IC package 102 depicts a post flux-removal condition. In an embodiment a liquid is used to wash any residual flux from the region of the reflowed solder bump 415.

FIG. 4C also depicts further processing of the IC package 403 such that the IC die 410 has been reflow mounted to the mounting substrate 412. The IC die 410 therefore makes electrical communication to the mounting substrate 412 though the solder bumps 415.

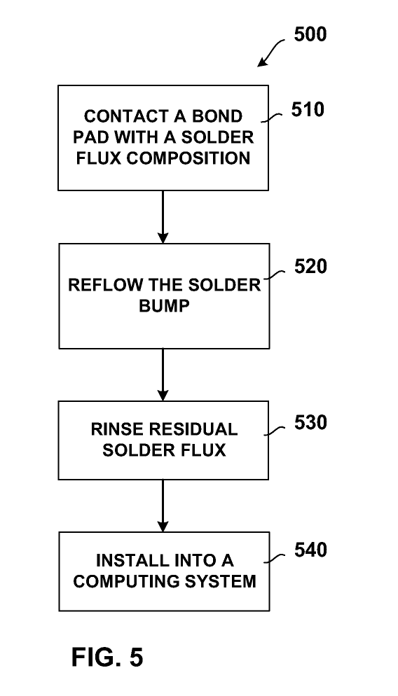

FIG. 5 is a flow chart 500 that describes process flow embodiments.

At 510, the process includes contacting a solder flux composition to a mounting substrate. The contacting process can include any of the above-given methods, depending upon the specific requirement. In an embodiment, the process commences and terminates at 510.

At 520, the process includes heating the solder flux composition to the reflow temperature of the solder bump. In an embodiment, the method commences at 510 and terminates at 520. In an embodiment, the process commences and terminates at 520.

At 530, the process includes washing the package to remove residual solder flux. In an embodiment, the method commences at 510 and terminates at 520.

This Detailed Description refers to the accompanying drawings that show, by way of illustration, specific aspects and embodiments in which the present disclosure may be practiced. These embodiments are described in sufficient detail to enable those skilled in the art to practice the disclosed embodiments. Other embodiments may be utilized and structural, logical, and electrical changes may be made without departing from the scope of the present disclosure. The various embodiments are not necessarily mutually exclusive, as some embodiments can be combined with one or more other embodiments to form new embodiments.

The term “horizontal” as used in this document is defined as a plane parallel to the conventional plane or surface of a wafer or substrate, regardless of the orientation of the wafer or substrate. The term “vertical” refers to a direction perpendicular to the horizontal as defined above. Prepositions, such as “on”, “side” (as in “sidewall”), “higher”, “lower”, “over” and “under” are defined with respect to the conventional plane or surface being on the top surface of the wafer or substrate, regardless of the orientation of the wafer or substrate. The Detailed Description is, therefore, not to be taken in a limiting sense, and the scope of this disclosure is defined only by the appended claims, along with the full scope of equivalents to which such claims are entitled.

The Abstract is provided to comply with 37 C.F.R. § 1.72(b) requiring an abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A solder flux composition comprising:
a carboxylic acid;
a surfactant;
a resin;
an amine;
a solvent;
an organohalide; and
the solution, reaction, and mixture products thereof.

2. The solder flux composition of claim 1, wherein the carboxylic acid is present in a range from about 1% to about 7%.

3. The solder flux composition of claim 1, wherein the organohalide includes about 2% 2-ethylhexylamine hydrobromide.

4. The solder flux composition of claim 1, wherein the organohalide includes about 2% ethylhexylamine hydrobromide, and wherein the surfactant is present in a range from about 0.1% to about 10%.

5. The solder flux composition of claim 1, wherein the organohalide includes about 2% 2,3-dibromo-1,4-butanediol.

6. The solder flux composition of claim 1, wherein the organohalide includes about 2% 2,3-dibromo-1,4-butanediol, and wherein the surfactant is present in a range from about 0.1% to about 10%.

7. A solder flux composition comprising:
a carboxylic acid;
a surfactant;
a resin;
an amine;
a solvent;
mono-tert-butyl succinate; and
the solution, reaction, and mixture products thereof.

8. The solder flux composition of claim 7, wherein the mono-tert-butyl succinate is present in a concentration of about 0.2%.

9. The solder flux composition of claim 7, wherein the mono-tert-butyl succinate is present in a concentration of about 2%.

10. The solder flux composition of claim 7, wherein the mono-tert-butyl succinate is present in a concentration of about 0.2%.

11. A solder flux composition comprising:
a tartaric acid;
an amine;
a solvent;
a resin;
an organohalide; and
the solution, reaction, and mixture products thereof.

12. The solder flux composition of claim 11, wherein the organohalide includes about 2% 2-ethylhexylamine hydrobromide.

13. The solder flux composition of claim 11, wherein the organohalide includes about 2% ethylhexylamine hydrobromide, and wherein the surfactant is present in a range from about 0.1% to about 10%.

14. The solder flux composition of claim 11. wherein the organohalide includes about 2% 2,3-dibromo-1,4-butanediol.

15. The solder flux composition of claim 11, wherein the organohalide includes about 2% 2,3-dibromo-1,4-butanediol, and wherein the surfactant is present in a range from about 0.1% to about 10%.

16. The solder flux composition of claim 11, wherein the surfactant is present in a range from about 0.1% to about 10%.

17. A process comprising:
contacting a bond pad with a solder flux composition; and
reflowing a solder ball in contact with the solder flux composition and the bond pad;
wherein the solder flux composition includes one of:
a carboxylic acid; a surfactant; a resin; an amine; a solvent; an organohalide; and the solution, reaction, and mixture products thereof, or
a carboxylic acid; a surfactant; a resin; an amine; a solvent; mono-tert-butyl succinate; and the solution, reaction, and mixture products thereof; or
tartaric acid; an amine; a solvent; a resin; an organohalide; and the solution, reaction, and mixture products thereof.

18. The process of claim 17, wherein contacting the bond pad with the solder flux composition results in a contact angle for the carboxylic acid and organohalide composition, in a range from about 11° to about 15°.

19. The process of claim 17, wherein contacting the bond pad with the solder flux composition results in a contact angle for the carboxylic acid and mono-tert-butyl succinate composition, in a range from about 22° to about 25°.

20. The process of claim 17, wherein contacting the bond pad with the solder flux composition results in a contact angle for the tartaric acid and organohalide composition, in a range from about 14° to about 17°.
